(19) United States
(12) Patent Application Publication
(10) Pub. No.: US 2021/0321558 A1
(43) Pub. Date: Oct. 21, 2021

(54) Sowing and Seeding Unit

(71) Applicant: Ribouleau Monosem, Largeasse (FR)

(72) Inventors: Alexis Puichault, Cerizay (FR); Damien Dole, Bressuire (FR)

(21) Appl. No.: 17/145,184

(22) Filed: Jan. 8, 2021

(30) Foreign Application Priority Data
Apr. 15, 2020 (EP) 20169513.7

(51) Int. Cl. A01C 7/20; A01C 7/10; A01C 15/00

(52) U.S. Cl. CPC A01C 7/208; A01C 15/006; A01C 7/10

(57) ABSTRACT

Systems and methods for distributing granular products onto or into the soil, comprising a chassis, a first assembly for distributing a first granular product comprising a main hopper, fixed to a frame, which can move in relation to said chassis and is able to adopt a position known as the “lowered” position, which is the working position of said sowing unit, and a position known as the “raised” position, which is the maintenance position of said sowing unit, and that is able to move from said “lowered” position to said “raised” position and vice versa, said sowing unit also comprising a mechanism for tilting said frame and comprising a collapsible quadrangle or double quadrangle that connects said frame to said chassis, said tilting mechanism being arranged substantially perpendicular to the plane X-X′ formed by said chassis, and maintained substantially perpendicular to said plane X-X′ in said “lowered” and “raised” positions and when moving from one position to the other, and vice versa. The systems may include a seed drill comprising one or more sowing units.

### INCORPORATION BY REFERENCE TO ANY PRIORITY APPLICATIONS

This application claims priority benefit of EP Application No. 20169513.7 (Dkt. No. P29561-EP-PRI2), filed on Apr. 15, 2020. All of the above applications are incorporated by reference herein and are to be considered a part of this specification. Any and all applications for which foreign or domestic priority claim is identified in the Application Data Sheet as filed with the present application are hereby incorporated.

### BACKGROUND

### Field

The present application relates generally to a sowing unit for distributing at least one granular product, preferably a number of granular products at the same time, which includes at least a first mobile feed hopper. The present application also relates to a seed drill comprising such a sowing unit.

### Description of the Related Art

In agriculture, seed drills for distributing granular products, such as seeds, fertilizers or agrochemicals, typically comprise a plurality of sowing units carried by a main chassis, the latter generally being fitted with several wheels, allowing it to move in relation to the ground. These wheels can be mobile, raised or retracted, so that they are not in contact with the ground during maneuvers or when transporting the seed drill, for example.

Sowing units can be self-driven, but they are usually either pulled or towed by an agricultural machine, e.g. a tractor. In this case, they include mechanisms for attaching them to an agricultural machine or a main chassis. They also typically include mechanisms for opening a furrow in the soil, mechanisms for refilling it, one or more hoppers that are capable of storing and, during operation, handling a granular product, or different granular products, for sowing or spreading, sometimes simultaneously.

The sowing units are generally equipped with one or several distribution assemblies for distributing the granular products onto or into the soil, and in most cases one distribution assembly per type of granular product, each of which may possibly include or work in conjunction with a mechanism for conveying the granular products onto the soil. The distribution assembly, or each distribution assembly, works in conjunction with or is connected to a storage hopper for the granular products.

It is common practice to use swiveling and removable hoppers for seed drills that can spread different granular products at the same time. For example, document EP0140262 describes a seed drill comprising a seed hopper that pivots on its own axis, with respect to its supporting chassis, along a single axis that runs perpendicular to the chassis. The seed hopper can be pivoted backwards to enable it to be easily handled by an operator who can then lift it up and separate it from the chassis in order to replace it. Similarly, document EP0729698 describes a two-tank hopper, mounted to the end of an arm, pivoting on a single axis and set in motion by hydraulic jacks.

Furthermore, document FR2691039 describes a seed drill comprising a hopper that is not fitted to a frame. The seed hopper is fitted so that it can be moved between a raised position, a working position, above the soil tillage tools, immediately next to the rear of the tractor to which the seed drill is attached, and a lowered position, for filling and emptying the seed hopper or servicing the dosing mechanisms, whereby the seed hopper is located behind the seed drill. It is moved from one position to another by tilting or following an inclined plane, using two substantially parallel arms that are hinged at various points on the seed drill and hopper chassis, and using a hydraulic jack that connects one of the arms to the end of the other arm.

Similarly, document DE4417964 describes a seed drill comprising a hopper that is not fitted to a frame. The seed hopper is mounted in such a way that it can be moved between a first raised position, which is the working position, a lowered position for filling the seed hopper, and a second raised position for maintenance, in which the seed hopper and the seed drill tools are raised and moved from one position to another by means of a series of two parallelograms, each having two arms that are attached to an articulated portion of the seed drill frame in such a way that they can be moved. One of the two parallelograms has a third arm that is connected to an articulated portion of the chassis by means of a hydraulic jack and is connected to the hopper by a spring arm, which allows the hopper to be lowered as it is emptied when the seed drill is in operation.

### SUMMARY

In some embodiments, a sowing unit for distributing granular products onto or into the soil includes a chassis, a first assembly for distributing a first granular product comprising a main hopper, fixed to a frame, which can move in relation to the chassis and is able to adopt a position known as the “lowered” position, which is the working position of the sowing unit, and a position known as the “raised” position, which is the maintenance position of the sowing unit, and that is able to move from the “lowered” position to the “raised” position and vice versa, the sowing unit also comprising a mechanism for tilting the frame, comprising a collapsible quadrangle or double quadrangle that connects the frame to the chassis, the tilting mechanism being arranged substantially perpendicular to the plane X-X′ formed by the chassis, and maintained substantially perpendicular to the plane X-X′ in the “lowered” and “raised” positions and when moving from one position to the other, and vice versa.

The sowing unit may include at least one, or any suitable combination thereof, of the following characteristics or features. The sowing unit may include a mechanism for tilting the frame comprising a lower arm that is fixed and integral with the chassis, carrying two fixed lower pivot points about which a main connecting rod and a secondary connecting rod are articulated respectively, the frame being articulated relative to the main connecting rod at a first upper pivot point and the secondary connecting rod being articulated relative to an upper linkage arm at a second upper pivot point, with the upper linkage arm being connected to the frame or to the main connecting rod, the first and second upper pivot points being able to move in relation to said chassis. The distance between the lower bottom pivot point and the upper bottom pivot point of the lower arm may be greater than the distance between the bottom upper pivot point of the upper linkage arm and the upper pivot point at the top of the frame. The distance between the upper bottom pivot point of the lower arm and the bottom upper pivot point of the secondary connecting rod may be less than the distance between the lower bottom pivot point of the lower arm and the upper pivot point at the top of the frame. The lower arm may comprise a mechanism for supporting a pivot shaft whose axis forms one of the two lower pivot points and wherein the upper linkage arm comprises a mechanism for supporting a pivot shaft whose axis forms the second upper pivot point, the secondary connecting rod comprising a mechanism for engaging the pivot shafts. The main connecting rod may comprise a mechanism for supporting a lower pivot shaft whose axis forms one of the lower pivot points, as well as a mechanism for supporting an upper pivot shaft whose axis forms the upper top pivot point. The main connecting rod may be integral with the frame by means of a bracket. The sowing unit may also comprise a hitching mechanism incorporating a tool bar, to which the chassis is connected, as well as a mechanism for adjusting the vertical position of said sowing unit featuring an adjustable parallelogram or adjustable parallelepiped, positioned substantially horizontally, and being articulated in relation to the chassis by at least one pivot point, which is also a pivot point of the mechanism for tilting the frame. The first distribution assembly for the first granular product may also comprise a first mechanism for distributing the first granular product as a unit, which is integral with the frame and can therefore be moved with the frame, the sowing unit also comprising a first mechanism for conveying the first granular product to the soil, which is integral with the chassis and is therefore fixed in relation to the chassis. The first mechanism for distributing the first granular product as a unit may be fitted to an arm attached to the frame, which extends from the frame to the chassis, the arm being able to move in relation to the chassis and capable of engaging and disengaging from attachment means provided on the chassis and capable of supporting the arm. The sowing unit may also comprise a second distribution assembly for a second granular product, comprising a first additional hopper that is integral with the frame and can therefore move with the frame. The second distribution assembly for a second granular product may comprise a second unitary distribution mechanism that is integral with the frame and can therefore move in relation to the chassis. The sowing unit may also comprise a third assembly for distributing a third granular product to the soil, comprising a second additional hopper that is integral with the frame and can therefore move in relation to the chassis, and that may comprise a second mechanism for conveying said second granular product to the soil. The third assembly for distributing a third granular product to the soil may further comprise a third unitary distribution mechanism that is integral with the frame or with the second additional hopper, and can therefore be moved in relation to the chassis, the sowing unit further comprising a third mechanism for conveying the third granular product to the soil, which is integral with the chassis and is therefore fixed in relation to the chassis.

This disclosure also relates to a seed drill with one or several sowing units.

### BRIEF DESCRIPTION OF THE DRAWINGS

FIG. 1 is a diagram illustrating a side view of a sowing unit with the main hopper in the lowered position.

FIG. 2 is a diagram illustrating a side view of a sowing unit with the main hopper in the lowered position.

FIG. 3 is a diagram of the sowing unit's main hopper.

FIG. 4 is a diagram showing a side view of the sowing unit in FIGS. 1 and 2, but with the main hopper in the raised position.

FIG. 5 is the same as FIG. 4.

FIG. 6 is a diagram showing a rear view of the sowing unit with the main hopper in the raised position.

FIG. 7 is a diagram showing a side view of a cross-section of the tilting mechanism in the folded position.

FIG. 8 is a diagram showing a side view of the tilting mechanism at the time of its deployment.

FIG. 9 is a diagram showing a side view of the tilting mechanism which is deployed.

FIG. 10 is a diagram showing a first perspective view of the tilting mechanism which is deployed.

FIG. 11 is a diagram showing a second perspective view of the tilting mechanism which is deployed.

### DETAILED DESCRIPTION

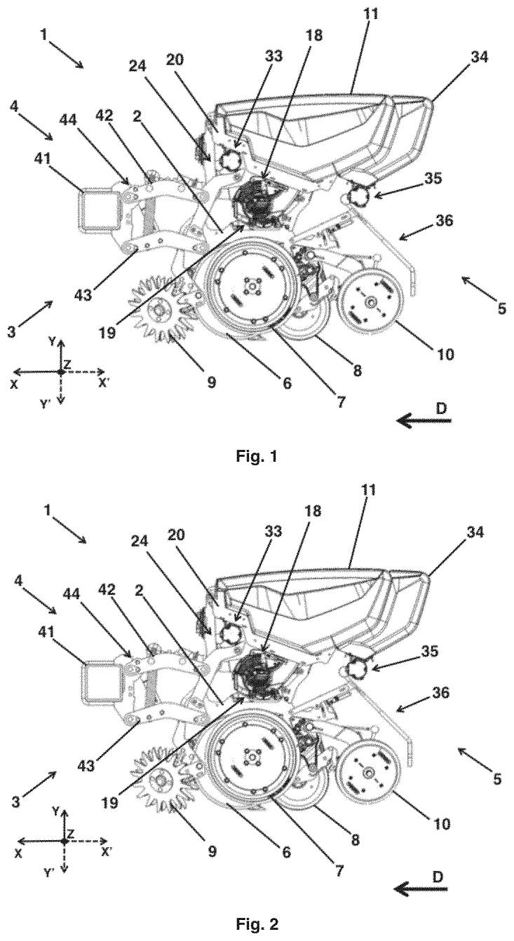

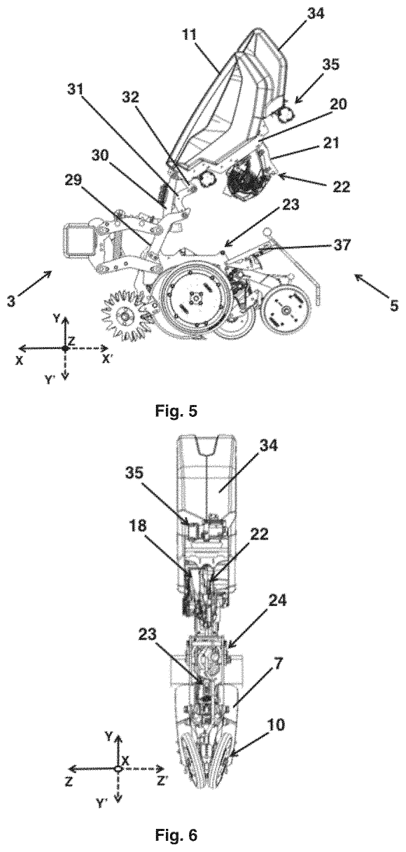

In the following description and claims, the terms “top”, “bottom”, “above”, “below”, “upper”, “lower”, “vertical” and “horizontal”, “front” and “rear” refer to the normal position of the sowing unit 1, and of its component parts during normal use and, in particular, they refer to its or their position(s) as shown in FIGS. 1 to 11.

The sowing unit 1 is mounted on a chassis 2, which is either automatically driven, or carried or towed by an agricultural machine, for example a tractor. The chassis 2 extends approximately horizontally in the X-X′ plane and comprises a front part 3, which is defined according to the direction of travel D of the sowing unit 1 during normal use, as shown in FIG. 1. For a towed sowing unit 1, this is the part located close to the rear of the agricultural machine. It is equipped with a hitching mechanism 4 that allows it to be connected to and disconnected from the agricultural machine, and a rear part 5, which is opposite said front part 3.

Preferably, the hitching mechanism 4 comprises a tool bar 41, to which the chassis 2 is connected by means of a mechanism for adjusting the vertical position of the sowing unit 1 relative to tool bar 41 along the Y′-Y-axis. This adjustment mechanism comprises an adjustable parallelogram 44 comprising at least two series of upper arms 42, preferably also two series of lower arms 43 substantially parallel to the upper arms 42. The adjustable parallelogram 44 is hinged with respect to the chassis 2 with at least one pivot point on the chassis 2, preferably two pivot points, advantageously two sets of two pivot points, thus allowing the upper arms 42 and the lower arms 43 to be pivoted with respect to the chassis 2.

The sowing unit 1 also comprises a mechanism 6 for opening a furrow in the soil, preferably at a controlled depth, which comprises opening discs, and preferably also one or more gauge wheels 7 for adjusting the depth of the furrow according to their position, and possibly also a means of shaping the bottom of the furrow.

The sowing unit 1 may comprise a mechanism 8 for compacting one or more granular products deposited at the bottom of the open furrow. Preferably, this mechanism 8 includes and/or incorporates at least one press wheel.

The sowing unit 1 also comprises a mechanism 10 for filling the furrow, which includes one or more closing discs or wheels that extend behind the mechanism 6 for opening the furrow and behind the compacting mechanism 8, if present. Preferably, this mechanism 10 is arranged behind the sowing unit 1.

In addition, the sowing unit 1 may comprise a debris removal mechanism 9 for removing crop residues, clumps of earth or stones, which comprises at least one rotating wheel arranged in front of the sowing unit 1.

The sowing unit 1 comprises at least one first distribution assembly for a first granular product, which is preferably a seed or grain, and which is capable of depositing the first granular product between the mechanism 6 for opening the furrow.

This first assembly comprises a hopper 11, referred to as the “main” hopper, which is capable of storing, and, during operation, handling the seeds to be sown, and which is preferably located in the upper part of the chassis 2, above, level with or behind the furrow opening mechanism 6 and in front of the furrow filling mechanism 10.

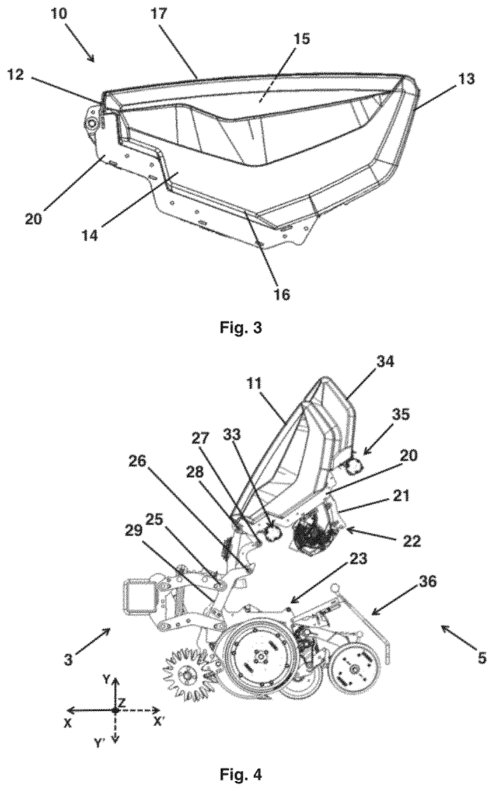

The main hopper 11 may take on any suitable or possible size and shape, which determines its internal volume. Preferably, it has a substantially parallelepiped shape and comprises a front panel 12, a rear panel 13 opposite the front panel 12, a first side panel 14, a second side panel 15 opposite the first side panel 14, a bottom panel 16 and a top panel 17 opposite the bottom panel 16 (FIG. 3), the top panel 17 preferably being an opening, or partial opening, in order to enable at least the first granular product to be loaded, and closable, and closed when in operation, by a movable cover.

The first distribution assembly also comprises a first distribution mechanism 18 for unitary distribution of the first granular product separately from the seeds to be sown, which is in communication with the main hopper 11 during operation, for example, by means of an opening, preferably one that can be closed, in the bottom panel 16 of the main hopper 11. This first unitary distribution mechanism 18 preferably uses a pneumatic principle, whereby the seeds are loaded one by one, using suction or negative pressure, onto a honeycombed distribution disc that is positioned substantially vertically, and which rotates and releases or extracts the seeds one by one, either by blowing or stopping the vacuum (negative pressure), or by means of mechanical extraction. For these purposes, the first distribution assembly may comprise or work in conjunction with a suction and/or blowing mechanism.

The first distribution mechanism 18 is preferably arranged under the main hopper 11, with a mechanism 6 above and behind it for opening a furrow, e.g. for depositing the seeds by gravity. This first distribution mechanism 18 is capable of depositing the first granular products between the mechanism 6 for opening the furrow, thus depositing the first granular products in the open furrow. The first distribution mechanism 18 preferably cooperates or communicates with a first conveyor mechanism 19 during operation which directs the seeds as they fall and prevents them from falling out of the furrow, the first conveyor mechanism 19 cooperating advantageously also with a mechanism for transferring the seeds from the first distribution mechanism's distribution disc to the first mechanism 19 for conveying the seeds into the soil.

Preferably, the main hopper 11 is attached to a rigid frame 20 by any suitable means. The frame 20 is preferably attached to the outer surface of the front panel 12 of the main hopper 11, and possibly also to the outer surface of the bottom panel 16, and follows the contour of this (these) panel(s) 12, 16, if this (these) panel(s) is (are) not straight (FIG. 3).

The first distribution assembly's first distribution mechanism 18 can be attached to the chassis 2; however, it is preferably also be fixed to the frame 20 and thus attached to the main hopper 11. For embodiments in which the first distribution mechanism 18 comprises a mechanism for transferring the granular products to the first conveying mechanism 19, this transfer mechanism is also attached to the main hopper 11. They are attached to the frame 20, either directly or via the distribution mechanism 18.

The first distribution mechanism 18 is preferably attached to an arm 21, which is fixed to the frame 20, protruding and extending from the frame 20 towards the chassis 2, substantially vertically from top to bottom, possibly at an angle (FIG. 4). Its free end 22, i.e. the end opposite to the one attached to the frame 20, can be used to connect to and disconnect from the chassis 2, possibly by force, via the attachment mechanism 23 provided on the chassis, which has the advantage of providing a locking point on the chassis 2 for the frame 20.

For example, the free end 22 of the arm 21 can be fitted with one or several hooks, preferably pivoting, which engage with a transverse pin, along the Z-Z′ axis, provided on the chassis 2 and attached to the latter, or a latch on the arm 21, which connects to the centering pins located on the chassis 2. The free end 22 of the arm 21 may also be equipped with a through hole, and the attachment mechanism 23 of the chassis 2 may also comprise a mounting bracket itself equipped with a through hole, these holes being designed to hold a removable pin or spindle.

The frame 20 is movably connected to the chassis 2 of the sowing unit 1 in such a way that the frame 20, and thus all connected components, e.g. the main hopper 11, can be pivoted in relation to the chassis 2, not by a simple swiveling movement with a single swivel point or a single swivel axis on the chassis 2, but by a forward rotational movement of the sowing unit 1 together with a substantially horizontal sliding movement.

The frame 20 can adopt both a “lowered” and “raised” position, in relation to the chassis 2, and can be moved from one position to the other.

The lowered position is that in which the frame 20, and therefore at least the main hopper 11, is(are) substantially horizontal, substantially in the X-X′ plane, and close to the chassis 2, as shown in FIGS. 1 and 2. This is the working position of the main hopper 11 during normal operation on the seed drill 1 and the normal working position of the seed drill 1 during normal operation.

In the raised position, the frame 20, and with it at least the main hopper 11, is in a substantially vertical position, substantially in the Y-Y′ plane, or substantially at an angle, substantially distanced from the chassis 2, as shown in FIGS. 4 to 6. This is the seed drill 1 maintenance position.

Moving the frame 20, and therefore the main hopper 11, from the lowered position, the working position, to the raised position, the maintenance position, and vice versa, is achieved by means of the tilting mechanism, which is mechanical, not pneumatic or hydraulic.

Preferably, the tilting mechanism acts as a collapsible parallelogram, without being strictly limited to a parallelogram in the geometrical sense of the term. The tilting mechanism comprises an articulated quadrangle 24, which is preferably not a parallelogram 24, but this is not impossible. The quadrangle 24 has a shape substantially perpendicular to the plane formed by the chassis 2, and is therefore substantially arranged in the Y-Y′ plane, regardless of whether the frame 20 is in the lowered or raised position, and remains substantially in this perpendicular position when the frame 20 is moved from the lowered to the raised position and vice versa.

The articulated quadrangle 24 has the advantage of not only eliminating the need for hydraulic or pneumatic mechanisms to move from one position to the other, but also provides the frame 20 with a stable raised position that cannot be achieved by a simple swivel movement around a single swivel point or a single swivel axis. This tilting mechanism also has the advantage of allowing the frame 20 to be moved freely, giving easy access to the components of the sowing unit 1.

Preferably, the collapsible quadrangle 24 comprises a lower arm 29 fixed in relation to the frame 2, a main connecting rod 30, a secondary connecting rod 31 and an upper linkage arm 32, and comprising four pivot points 25, 26, 27, 28, to which the lower and upper arms 29, 32 and the connecting rods 30, 31 are articulated. The lower arm 29 has two lower pivot points 25, 26 fixed in relation to the chassis 2, about which the main connecting rod 30 and the secondary connecting rod 31 are articulated respectively, the main connecting rod 30 also being pivoted in relation to the frame 20 at a first upper pivot point 28 and the secondary connecting rod 31 being pivoted in relation to the frame 20, and, in particular, in relation to the upper linkage arm 32, with a second upper pivot point 27, the first and second upper pivot points 27 and 28 being able to be moved in relation to the chassis 2 when the frame 20 is moved from its lowered position to its raised position, and vice versa.

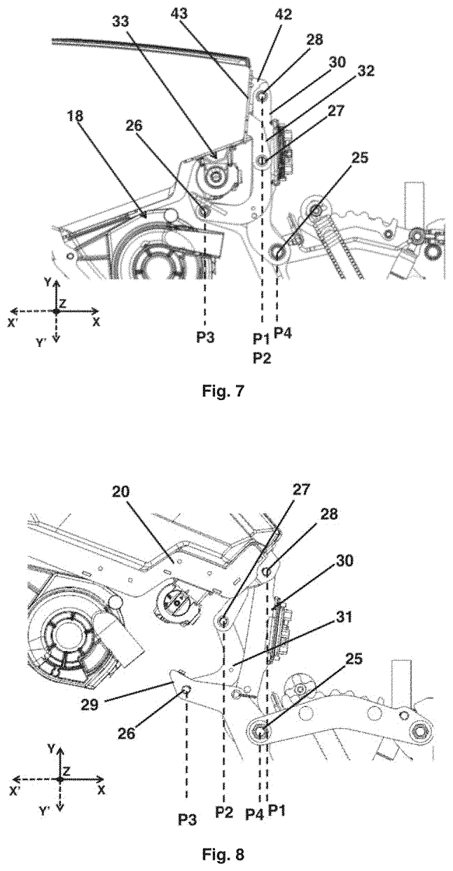

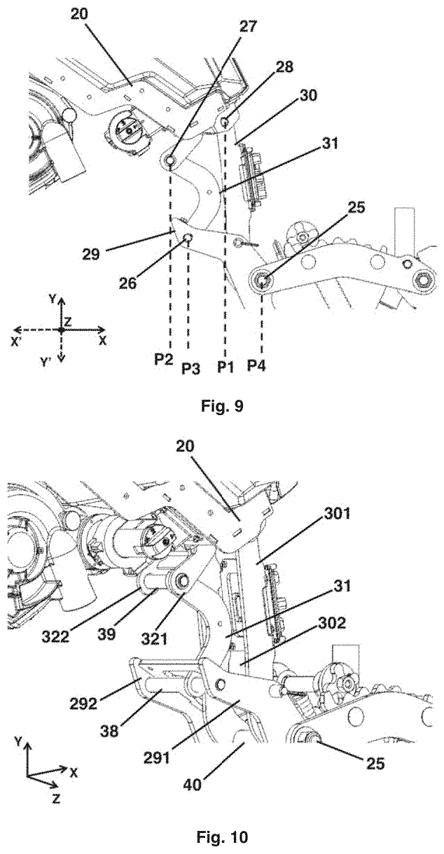

The collapsible quadrangle 24 essentially folds in on itself, or is partially open, when the frame 20 is in the lowered position (FIG. 7), and unfolds as it moves from one position to the other (FIG. 8), and is unfolded, or open, when the frame 20 is in the raised position (FIG. 9), while maintaining a position that is substantially perpendicular to the X-X′ plane.

The lower arm 29 of the collapsible quadrangle 24 is fixed to the chassis 2 and extends from it at an upward angle to the rear of the chassis 2. It comprises the lower pivot points 25, 26, which can be positioned on the same plane, e.g. the plane formed along the X-X′ axis, however, preferably not on the same horizontal plane, but on a plane that is at an angle to the X-X′ plane. This then provides a lower bottom pivot point 25 and an upper bottom pivot point 26. The lower arm 29 preferably comprises a curved upper part running upwards and to the rear of the chassis 2, whose upper end comprises the upper bottom pivot point 26.

Preferably, the lower bottom pivot point 25 is also a pivot point of the horizontal collapsible parallelogram 44 for vertically adjusting the sowing unit 1. This is advantageously the pivot point between the chassis 2 and the upper arm 42 of the collapsible parallelogram 44.

The lower bottom pivot point 25 of the lower arm 29 attached to the chassis 2 is preferably arranged away from the upper bottom pivot point 26 at a distance greater than the distance between the lower upper pivot point 27 and the upper top pivot point 28 of the upper linkage arm 32.

The main connecting rod 30 of the collapsible quadrangle 24 can be articulated and moved, and connects the chassis 2 to the frame 20. It can be articulated in relation to the chassis 2, and, in particular, in relation to the lower arm 29 at the lower bottom pivot point 25 and can be moved in relation to the frame 20 at the upper top pivot point 28.

The secondary connecting rod 31 is also articulated and moveable, and connects the chassis 2 to an upper arm 32, which is itself articulated and moveable, and which links the secondary connecting rod 31 to the frame 20 or links the secondary connecting rod 31 to the main connecting rod 30. The secondary connecting rod 31 can be articulated in relation to the chassis 2, in particular in relation to the lower arm 29 at the upper bottom pivot point 26 and in relation to the upper linkage arm 32 at the lower top pivot point 27. The upper linkage arm 32 can be fixed to the frame 20 or can be moved at the upper top pivot point 28.

Preferably, the secondary connecting rod 31 is shorter than the main connecting rod 30 in such a way that the distance between the upper bottom pivot point 26 and the lower top pivot point 27 is smaller than the distance between the lower bottom pivot point 25 and the upper top pivot point 28.

The main connecting rod 30 is preferably at least equal in length to or longer than the sum of the lengths of the secondary connecting rods 31 and upper connecting rods 32 such that the distance between the lower bottom pivot point 25 and the upper top pivot point 28 is at least equal to or greater than the sum of the distances between the lower bottom pivot point 26, the lower top pivot point 27 and the upper top pivot point 28.

In addition to the lowered and raised positions, the quadrangle 24 allows at least one intermediate position to be adopted whereby the main connecting rod 30 is in a position in which the pivot points 26, 27 and 28 are in alignment.

When the frame 20 is in the lowered position, the lower top pivot point 27 and the upper top pivot point 28 are substantially vertically aligned with each other in the Y-Y′ plane. These pivot points 27 and 28 are substantially on the same projected vertical line P1, P2, on the ground, or on an X-X′ plane. The projection points P1 and P2 of the upper pivot points 28 and 27, respectively, are at a relative position between the projection point P3 of the upper bottom pivot point 26 and the projection point P4 of the lower bottom pivot point 25 (FIG. 7).

When the frame 20, and therefore the main hopper 11, is lifted, the main connecting rod 30 swivels in relation to the lower bottom pivot point 25 in such a way that the upper top pivot point 28 moves towards the front of the chassis 2 in a substantially horizontal sliding movement along the X-X′ plane. The projection P1 of the upper top pivot point 28 moves forward and exceeds the projection P4 of the lower bottom pivot point 25. At the same time, the secondary connecting rod 31 swivels in relation to the upper bottom pivot point 26 and extends at an angle towards the top of the chassis 2 and then horizontally towards the rear of the chassis 2, allowing a lower top pivot point 27 to move upwards, and then towards the rear of the chassis 2. The projection P2 of the lower top pivot point 27 then moves backward towards the projection P3 of the upper bottom pivot point 26 (FIG. 8). As the lower top pivot point 27 moves, the main connecting rod 30 pivots again in relation to the lower bottom pivot point 25, but in the opposite direction, so that the upper top pivot point 28 moves towards the rear of the chassis 2 in a substantially horizontal sliding movement, exceeding its relative position that is occupies when the frame 20 is in the lowered position, until the lower top pivot point 27 exceeds the relative position of the upper bottom pivot point 26.

When the projection P2 of the lower top pivot point 27 moves backwards towards the projection P3 of the upper bottom pivot point 26, the lower top pivot point 27 reaches an unstable equilibrium position on the collapsible quadrangle 24 where the projections P2 and P3 are merged. The projection P1 of the lower bottom pivot point 25 protrudes towards the rear of the chassis 2 beyond the projection P4 of the lower bottom pivot point 25 to return to its relative position it occupies when the frame 20 is in the lowered position, between the projections P3 and P4. The projection P2 of the lower upper pivot point 27 moves to the rear of the chassis 2 and exceeds the projection P3 of the upper lower pivot point 26 (FIG. 9).

In this position, the frame 20, and thus the main hopper 11, is in the raised position, blocked by the upper end of the main connecting rod 30 coming into contact with the frame 20 or a blocking device or on a panel of the main hopper 11, locking the frame 20 and the main hopper 11 in this position without the need for additional blocking mechanisms.

In order to move the frame 20, and therefore the main hopper 11, from the raised to the lowered position, the collapsible quadrangle 24 folds in an opposite movement to that described for its opening. The main connecting rod 30 pivots in relation to the lower bottom pivot point 25 causing the upper top pivot point 28 to move towards the front of chassis 2 in a substantially horizontal sliding movement, while the secondary connecting rod 31 moves towards the front of chassis 2 horizontally and then at an angle towards the bottom of chassis 2, causing the upper lower upper pivot point 27 to move towards the front and then the bottom of chassis 2. Projection P1 moves to the front of the chassis 2, towards and past projection P4, while projection P2 also moves to the front of the chassis 2, towards projection P4, and past projection P3 of the upper bottom pivot point 26. As the lower upper pivot point 27 moves, the main connecting rod 30 pivots again in relation to the lower bottom pivot point 25, but in the opposite direction, causing the upper top pivot point 28 to move towards the rear of the chassis 2 in a substantially horizontal sliding movement to re-adopt its relative position, the frame 20 and thus the main hopper 11 moving into the lowered position. Projections P1 and P2 are aligned substantially on the same vertical axis between projections P3 and P4.

For embodiments in which the first distribution mechanism 18 is attached to an arm 21 of the frame 20, lifting the frame 20 to its raised position allows the free end 22 of the arm 21 to be disengaged from its attachment mechanism 23 that fixes it to the chassis 2, while moving the frame 20 to its lowered position allows the free end 22 to engage with the attachment mechanism 23 that fixes it to the chassis 2, thus locking the frame 20 in its lowered position.

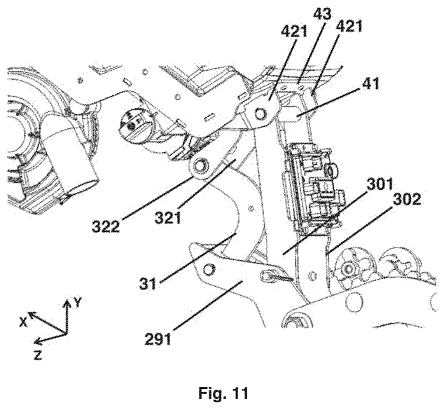

The tilting mechanism preferably comprises a double collapsible quadrangle, two adjacent quadrangles, parallel and not in series, sharing a common side (FIGS. 10 and 11) and positioned substantially perpendicular to the chassis 2. It can also be a double collapsible parallelogram, where two adjacent parallelograms form a collapsible parallelepiped.

For embodiments where the tilting mechanism comprises a collapsible double quadrangle, the lower arm 29 comprises a first side section 291 and a second side section 292, positioned opposite and substantially parallel to the first side section 291, each comprising a mechanism for supporting a pivot shaft 38, preferably comprising or having the form of through holes, whose axis forms the upper bottom pivot point 26. The upper arm 32 comprises a first side section 321 and a second side section 322, positioned opposite and substantially parallel to the first side section 321, and comprises a mechanism for supporting a pivot shaft 39, preferably comprising or in the form of through holes, whose axis forms the lower upper pivot point 27. The secondary connecting rod 31 preferably comprises a mechanism for supporting at each end, preferably a through hole, which engages the pivot shaft 38 at one end and the pivot shaft 39 at the other end. The main connecting rod 30 comprises a first side section 301 and a second side section 302, which is opposite and positioned substantially parallel to the first side section 301, and which comprises a mechanism for supporting a lower pivot shaft 40 whose axis forms the lower bottom pivot point 25, and a mechanism for supporting an upper pivot shaft 41 whose axis forms the upper top pivot point 28 (FIG. 11).

Preferably, the main connecting rod 30 is fixed to the frame 20 by means of a bracket 42, which in turn is fixed directly to the frame 20, preferably by means of a fixing plate 43 attached to the frame 20 itself, or to a panel of the main hopper 11. Advantageously, the bracket 42 comprises a first side section 421 and a second side section 422, positioned opposite and substantially parallel to the first side section 422, comprising a mechanism, e.g. through holes, for supporting the shaft 41.

Even if the upper linkage arm 32 can be connected to the frame 20 at the upper top pivot point 28, e.g. by means of a through hole engaging with the shaft 41 arranged at its end opposite to that with the lower upper pivot point 27, i.e. opposite to the end with the through hole for supporting the shaft 39, it is preferably fixed directly to the frame 20, advantageously via the fixing plate 43 supporting the bracket 42.

For embodiments where the first distribution mechanism 18, and possibly also, if present, the mechanism for transferring the first granular products to the first conveying mechanism 19, are fixed to the arm 21 of the frame 20, the secondary connecting rod 31 can be bent or curved to ensure that, in the lower position of the frame 20, it is positioned against the first distribution mechanism 18, which has the advantage of producing a more compact sowing unit 1.

It is also advantageous to provide for mechanisms for automatic connection and disconnection between the first distribution mechanism 18, or the granular product transfer mechanism, if present, and the first conveyor mechanism 19, and/or between the first distribution mechanism 18 and the pneumatic system for feeding the granular products from the main hopper 11 to the first distribution mechanism 18.

The sowing unit 1 may also comprise a second distribution assembly for a second granular product, which may also be a seed or grain, but of a different nature than that of the first granular product, thereby allowing two crops to be planted at the same time. However, it is preferable that the second granular product is not a seed or grain, but a granular agrochemical product, or mixture of granular agrochemical products, such as fertilizers, herbicides, insecticides, nematicides, fungicides, slug pellets, or other equivalent pesticides.

The second distribution assembly is capable of distributing the second granular product into or onto the soil at least in front of the furrow opening mechanism 6, preferably behind the debris removing mechanism 9, if present, and/or between the furrow opening mechanisms 6.

The second distribution assembly comprises a first hopper, known as the first additional hopper, which can adopt all possible or suitable dimensions and shapes, defining an internal volume, and capable of containing, and, during operation, handling one or several granular agro-chemical products. This first additional hopper is preferably arranged in the upper part of the chassis 2, above, level with or behind the mechanism 6 for opening the furrow, in front of the mechanism 10 for filling the furrow, advantageously it is arranged in front of and attached to the main hopper 11, in such a way that the two hoppers can advantageously share a common panel, or that the first additional hopper can be an integral part of, or integrated into, the main hopper 11. Therefore, the additional hopper is attached to the frame 20.

The second distribution assembly comprises a second distribution mechanism 33 for the unitary distribution of a second granular product into or onto the soil, which, when in operation, is in communication with the first additional hopper, e.g. through an opening, preferably one that can be closed off, in the bottom panel of the said additional hopper. This second unitary distribution mechanism 33 preferably works in conjunction with, comprises or also includes the second conveyor mechanism, when in operation, and also may also comprise a transfer mechanism for transferring the second granular product from the second unitary distribution mechanism 33 to the second conveyor mechanism.

The second unitary distribution mechanism 33 of the second distribution assembly may be attached to the chassis 2; however, preferably, it is also attached to the frame 20 using any suitable means. In this way, raising the frame 20 from its lower position to its upper position also allows the user of the sowing unit 1 to have easy access to the second unitary distribution mechanism 33 in order to check, maintain or replace it. Preferably, in these embodiments, it is also advantageous to provide for the use of automatic connection and disconnection mechanisms between the second unitary distribution mechanism 33 and the second conveying mechanism.

The sowing unit 1 may also comprise a third distribution assembly for distributing a third granular product, which is preferably not a seed or grain, but a granular agrochemical product or a mixture of granular agrochemical products.

The third distribution assembly is able to distribute the second granular product on into or onto the soil at least between the mechanism 6 for opening the furrow and/or after the mechanism 10 for filling the furrow, and/or after the mechanism 8 for compacting the furrow.

The third distribution assembly comprises a second additional hopper 34, which can be of any possible or suitable size and shape, defining an internal volume and which is capable of containing and, during operation, handling one or several granular agrochemical products. This second additional hopper is preferably arranged in the upper part of the chassis 2, above, level with or behind the mechanism 10 for filling the furrow, advantageously arranged behind and attached to the main hopper 11, in such a way that the two hoppers 11 and 34 can advantageously share a common panel.

The third distribution assembly comprises a third distribution mechanism 35 for the unitary distribution of a third granular product onto or into the soil, which, during operation, is in communication with the second additional hopper 34, for example through an opening, preferably one that can be closed off, in the lower panel of said hopper 34. This third distribution mechanism 35 preferably also works in conjunction with, includes or serves as a third conveyor mechanism 36, and may also comprise a transfer mechanism for transferring the second granular product from the third distribution mechanism 35 to the third conveyor mechanism 36.

The third unitary distribution mechanism 35 may be attached to the chassis 2; however, it is preferably fixed directly to the frame 20 by any suitable means, or to the second additional hopper 34, which in turn is attached to the main hopper 11, which is also attached to the frame 20. Thus, by raising the frame 20 from its lower position to its upper position, the user of the sowing unit 1 can also easily access the third unitary distribution mechanism 35 in order to check, maintain or replace it. Preferably in these embodiments, it is also advantageous to provide for automatic connection and disconnection mechanisms between the third distribution mechanism 35 and the third conveyor mechanism 36.

Preferably, the third conveyor mechanism 36 is supported by an arm 37 which is fixed and attached to the chassis 2, which extends from the chassis 2 advantageously at an angle upwards and to the rear of the chassis 2.

The seed drill comprises one or several sowing units 1, preferably mounted on a load-bearing chassis, carried or towed by an agricultural machine. The load-bearing chassis then comprises a hitching mechanism to connect it to/disconnect it from the agricultural machine that carries or tows it. The seed drill preferably comprises one or several wheels, preferably mobile so that they can be lifted or retracted to avoid contact with the ground during maneuvering or when transporting the seed drill, for example.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for sowing and seeding units have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for sowing and seeding units. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication. For example, actions such as “positioning an electrode” include “instructing positioning of an electrode.”

The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

In summary, various embodiments and examples of systems and methods for sowing and seeding units have been disclosed. Although the systems and methods for sowing and seeding units have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

What is claimed is:

1. Sowing unit for distributing granular products onto or into the soil, comprising a chassis, a first assembly for distributing a first granular product comprising a main hopper, fixed to a frame, which can move in relation to said chassis and is able to adopt a position known as the “lowered” position, which is the working position of said sowing unit, and a position known as the “raised” position, which is the maintenance position of said sowing unit, and that is able to move from said “lowered” position to said “raised” position and vice versa, said sowing unit also comprising a mechanism for tilting said frame, comprising a collapsible quadrangle or double quadrangle that connects said frame to said chassis, said tilting mechanism being arranged substantially perpendicular to the plane formed by said chassis, and maintained substantially perpendicular to said plane in said “lowered” and “raised” positions and when moving from one position to the other, and vice versa.

2. Sowing unit according to claim 1, in which the mechanism for tilting the frame comprises a lower arm that is fixed and integral with the chassis, carrying two fixed lower pivot points about which a main connecting rod and a secondary connecting rod are articulated respectively, said frame being articulated relative to said main connecting rod at a first upper pivot point and said secondary connecting rod being articulated relative to an upper linkage arm at a second upper pivot point, with said upper linkage arm being connected to said frame or to said main connecting rod, said first and second upper pivot points being able to move in relation to said chassis.

3. Sowing unit according to claim 2, wherein the distance between the lower bottom pivot point and the upper bottom pivot point of the lower arm is greater than the distance between the bottom upper pivot point of the upper linkage arm and the upper pivot point at the top of the frame.

4. Sowing unit according to claim 2, in which the distance between the upper bottom pivot point of the lower arm and the bottom upper pivot point of the secondary connecting rod is less than the distance between the lower bottom pivot point of the lower arm and the upper pivot point at the top of the frame.

5. Sowing unit according to claim 2, in which the lower arm comprises a mechanism for supporting a pivot shaft whose axis forms one of the two lower pivot points and wherein the upper linkage arm comprises a mechanism for supporting a pivot shaft whose axis forms the second upper pivot point, the secondary connecting rod comprising a mechanism for engaging said pivot shafts.

6. Sowing unit according to claim 2, in which the main connecting rod comprises a mechanism for supporting a lower pivot shaft whose axis forms one of the lower pivot points, as well as a mechanism for supporting an upper pivot shaft whose axis forms the upper top pivot point.

7. Sowing unit according to claim 2, in which the main connecting rod is integral with the frame by means of a bracket.

8. Sowing unit according to claim 1, further comprising a hitching mechanism incorporating a tool bar, to which the chassis is connected, as well as a mechanism for adjusting the vertical position of said sowing unit featuring an adjustable parallelogram or adjustable parallelepiped, positioned substantially horizontally, and being articulated in relation to the chassis by at least one pivot point, which is also a pivot point of the mechanism for tilting the frame.

9. Sowing unit according to claim 1, in which the first distribution assembly for the first granular product also comprises a first mechanism for distributing said first granular product as a unit, which is integral with the frame and can therefore be moved with said frame, said sowing unit also comprising a first mechanism for conveying said first granular product to the soil, which is integral with the chassis and is therefore fixed in relation to the chassis.

10. Sowing unit according to claim 9, in which the first mechanism for distributing the first granular product as a unit is fitted to an arm attached to the frame, which extends from said frame to the chassis, said arm being able to move in relation to said chassis and capable of engaging and disengaging from attachment means provided on the chassis and capable of supporting said arm.

11. Sowing unit according to claim 1, further comprising a second distribution assembly for a second granular product, comprising a first additional hopper that is integral with the frame and can therefore move in relation to the frame.

12. Sowing unit according to claim 11, in which the second distribution assembly for a second granular product comprises a second unitary distribution mechanism that is integral with the frame and can therefore move in relation to the chassis, and possibly comprising a second mechanism for conveying said second granular product to the soil.

13. Sowing unit according to claim 11, further comprising a third assembly for distributing a third granular product to the soil, comprising a second additional hopper that is integral with the frame and can therefore move in relation to the chassis.

14. Sowing unit according to claim 13, in which the third assembly for distributing a third granular product to the soil further comprises a third unitary distribution mechanism that is integral with the frame or with the second additional hopper, and can therefore be moved in relation to the chassis, said sowing unit further comprising a third mechanism for conveying said third granular product to the soil, which is integral with the chassis and is therefore fixed in relation to the chassis.
